(19) United States
(12) Patent Application Publication
(10) Pub. No.: US 2025/0043626 A1
(43) Pub. Date: Feb. 6, 2025

(54) BEARING FOR SUPPORTING THE WINDING SHAFT OF A SHADE SYSTEM AND SHADE SYSTEM WITH SUCH A BEARING

(71) Applicant: Hunter Douglas Industries Switzerland GmbH, Luzern (CH)

(72) Inventor: Katharina VANGBERG-BRINKMANN, Loxstedt (DE)

(21) Appl. No.: 18/789,840

(22) Filed: Jul. 31, 2024

(30) Foreign Application Priority Data
Aug. 1, 2023 (DE) 10 2023 120 455.6

(51) Int. Cl. E06B 9/50; F16C 25/02

(52) U.S. Cl. CPC E06B 9/50; F16C 25/02

(57) ABSTRACT

A bearing (11) is for mounting a winding shaft (12) of a shade system (10), in particular a roller blind. The bearing (11) includes a holder (14) and an elongated bearing pin (18) extending therefrom. The winding shaft (12) can be easily mounted and dismounted with a low risk of damage, even in confined spaces. The bearing pin (18) includes a narrower spacer (20) and a wider bearing head (21) spaced from the holder (14) by the spacer (20).

### CROSS REFERENCE TO RELATED APPLICATIONS

This application claims the benefit of priority under 35 U.S.C. § 119 of German Application 10 2023 120 455.6, filed Aug. 1, 2023, the entire contents of which are incorporated herein by reference.

### TECHNICAL FIELD

The invention relates to a bearing for supporting the winding shaft of a shade system, in particular a roller blind, with a holder and an elongated bearing pin (bearing journal) extending therefrom. The invention also relates to a shade system with such a bearing.

### BACKGROUND

The bearing pins of the bearings for winding shafts of shade systems, in particular roller blinds, are usually cylindrical. For installation, the winding shafts are pushed onto these cylindrical bearing pins with their bearing mounts (bearing holders/bearing receptacles), which are also usually cylindrical, and pulled off again for disassembly. There must only be a small angle between the bearing pin and the bearing mount, as otherwise the bearing pin and bearing mount could become jammed. There is even a risk of damage during disassembly if the winding shaft sags considerably on one side due to its own weight. In particular, the desire for a small remaining light gap and the resulting need for installation within a reveal (recess/soffit), especially a deep reveal, leads to problems during installation and removal, as large swivel angles are required for installation due to the relatively small remaining space, especially with deep reveals.

### SUMMARY

The problem underlying the invention is to provide a bearing for supporting the winding shaft of a shade system, in particular a roller blind, on which the winding shaft can be mounted and dismounted easily and with little risk of damage, even in confined spaces.

The problem is solved, with respect to a bearing of the type mentioned at the beginning, in that the bearing pin has a narrower spacer and a wider bearing head spaced from a holder by the spacer. In a shade system of the type mentioned at the beginning, the problem is solved by a bearing with the features of the invention.

In this way, the winding shaft of a shade system can be easily installed even if a relatively large swivel angle is required and, in particular, dismantled without any major risk of damage.

A further development of the invention is characterized in that the bearing head has a round, in particular circular, outer contour at least in sections. This results in a smooth-running and low-wear bearing.

Another further development of the invention is characterized in that the bearing head is bead-shaped, in particular circular with a semi-circular cross-section or is spherical. This configuration is robust and smooth-running.

Another advantageous embodiment is characterized in that the bearing head is circular disk-shaped and preferably has four, in particular lateral, particularly preferably semi-circular, webs, which are spaced apart from each other, in particular equally spaced, along the circumference. Such an embodiment saves material and is nevertheless robust and smooth-running.

With the invention, it is also advantageous if the spacer has a cylindrical outer contour, at least in sections, or, in particular, has four webs which have a common cylindrical envelope end. Such a structure is easy to implement and nevertheless stable.

Another embodiment of the invention is characterized in that the spacer is widened, in particular conically, at its base facing the holder. This ensures that the winding shaft is kept at a distance from the holder. This reduces friction and wear.

Another further development which is also conceivable independently of the invention is characterized by a fastening piece for fastening to a wall or ceiling, in particular a reveal, which preferably has a support section, onto which the holder can be attached (plugged), and a fastening section for fastening to the wall or ceiling, in particular the reveal, the support section and/or the fastening section is preferably shaped in the form of a plate. Such a fastening piece can be easily produced as a sheet metal stamped part. It is stable and load-bearing.

Yet another further development of the invention is characterized in that the holder has grooves on opposite sides from one another, in particular facing one another, for receiving the fastening piece, in particular its support section. In this way, the holder can be simply and stably attached to the fastening piece, in particular its support section. This applies in particular if the fastening piece, especially its support section, is plate-shaped.

A further advantageous embodiment of the invention is characterized in that the holder has at least one latching hook for latching to a latching section, in particular at least one latching opening, of the fastening piece, in particular its support section, wherein preferably a slide, in particular a displaceable slide, is provided on the holder, which in particular has a ramp for unlatching the latching hook. This latching results in a simple and reliable connection, which can be released again easily and without damage due to the slide for disassembly.

The shade system includes the bearing and a winding shaft, wherein the winding shaft preferably has a, in particular cylindrical, bearing mount for the bearing head, wherein the bearing mount particularly preferably has a stop, in particular for the bearing head. The winding shaft of such a shade system can be mounted and dismounted on the holder easily and without the risk of damage due to the relatively large swivel angle that can be implemented. The bearing mount should fit onto the bearing head with suitable bearing clearance.

In the following, an embodiment of the invention is explained in more detail with reference to the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiments of the invention is illustrated.

### BRIEF DESCRIPTION OF THE DRAWINGS

In the drawings:

FIG. 1 is a top view of a shade system with a winding shaft arranged on a bearing as an embodiment of the invention;

FIG. 2 is a sectional view taken along section line A-A of FIG. 1;

FIG. 3 is an enlarged perspective view of the holder of FIG. 1,

FIG. 4 is a top view of the shade system in a representation similar to FIG. 1, showing the winding shaft pivoted;

FIG. 5 is a sectional view taken along section line B-B of FIG. 4;

FIG. 6 is a front view of the holder of FIG. 1 in an unlatched state; and

FIG. 7 is a front view of the holder of FIG. 1 showing the holder in the disengaged state, largely pulled off a fastening piece.

### DESCRIPTION OF PREFERRED EMBODIMENTS

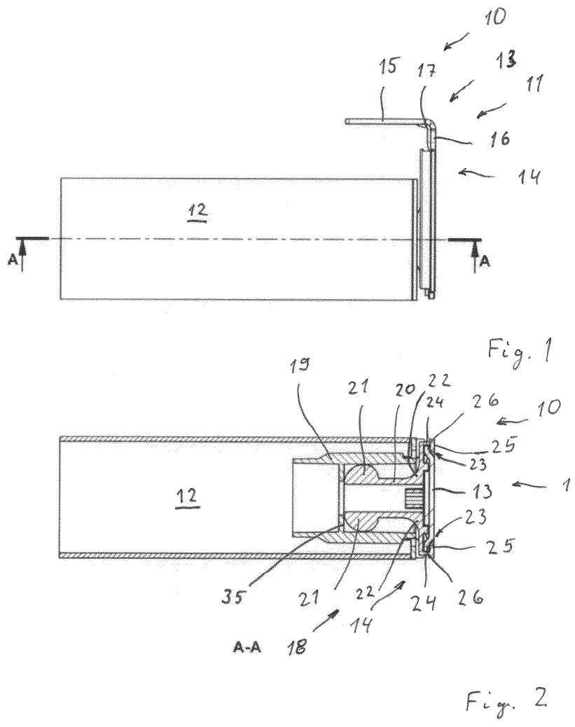

Referring to the drawings, FIG. 1 shows a shade system 10 with a winding shaft 12 arranged on a bearing 11 in a top view as an embodiment example of the invention. In the embodiment example shown, the shade system 10 is a roller blind, although a shade is not shown in the figure for the sake of clarity.

In the embodiment example shown, the bearing 10 has a mounting piece 13 and a holder 14. The mounting piece 13 has a fastening section 15 and a support section 16. In the embodiment example shown, the fastening section 15 and the support section 16 are plate-shaped. They are approximately at right angles to each other. In this way, the fastening piece 13 is formed in an L-shape as a sheet metal stamped and bent part. At the transition from the fastening section 15 to the support section 16, the fastening piece 13 has ribs 17 for reinforcement (stiffening).

FIG. 2 shows the section A-A of FIG. 1. As can be seen from the figure, the holder 14 has a bearing pin which interacts with a bearing mount 19 of the winding shaft 12. The bearing mount 19 has a stop 35 for the bearing pin 18. The bearing pin 18 has a spacer 20, at whose end facing away from a base of the holder 14, which is not provided with a reference number in the figure, a bearing head 21 is arranged, which is wider than the spacer 20. In the embodiment shown, the stop 35 is provided for cooperative interaction with the bearing head 21.

In the embodiment shown, the spacer is cylindrical and has an extension 22 at its end facing the base. The extension 22 widens towards the base and away from the bearing head 21. The extension 22 is shaped similar to a trumpet, but can also be conically widened.

The bearing head 21 is bead-shaped. In the embodiment example shown, the bead has a semi-circular cross-section. The bearing mount 19 is mounted on the bearing head 21 with the required bearing clearance and thus forms a bearing together with the latter, in the embodiment example shown a plain bearing of the winding shaft 12. During a winding movement of the winding shaft 12, the extension 22 ensures that the bearing mount and with it the winding shaft 12 are kept at a distance from the base of the holder 14.

The holder 14 has grooves 23 on its side facing away from the bearing head 21. In the embodiment example shown, the holder has two grooves 23 that face each other. To form the grooves 23, the holder 14 has spacer elements 24 at ends facing away from each other, with which strips 25 are spaced from the base of the holder 14.

The grooves 23 serve to accommodate wings 26 on sides of the fastening piece 13 that face away from each other. To ensure that the holder 14 does not protrude beyond the fastening piece 13, or protrudes only slightly, on its side facing away from the bearing head 21 when it is fitted onto the wings 26 with the grooves 23, the wings 26 are bent in an S-shape offset towards the holder 14.

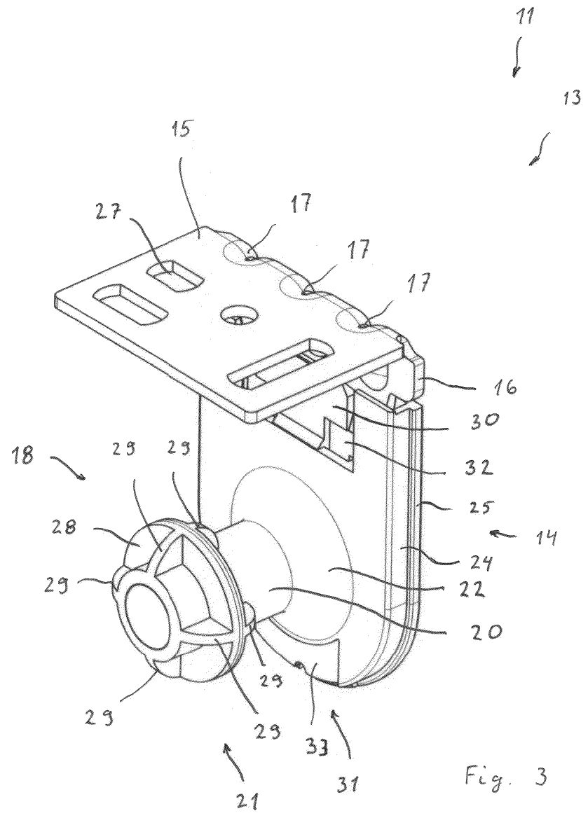

FIG. 3 shows the holder 14 of FIG. 1 in an enlarged perspective view. As can be seen from the figure, the fastening piece 13 has three pressed-in ribs 17 at the transition between the fastening section 15 and the support section 16. This stabilizes the angle between the fastening section 15 and the support section 16. In addition, the fastening section 15 has openings 27 for fastening the fastening section 15 to a wall or reveal using screws. The fastening section 15 has a total of four openings 27, of which only one opening 27 is provided with a reference number for a better clarity. The openings 27 are partially configured as elongated holes for better alignment of the fastening piece 13.

As can also be seen in FIG. 3, the bearing head 21 is not solid in the embodiment example shown. Rather, the bearing head has a disk 28, which forms the actual bearing, and, starting from the disk 28, webs 29 for stabilizing the disk 28. In the embodiment example shown, there are four webs 29 on each side, each of which is arranged in a quarter circle and equally distributed over the circumference of the disk 28.

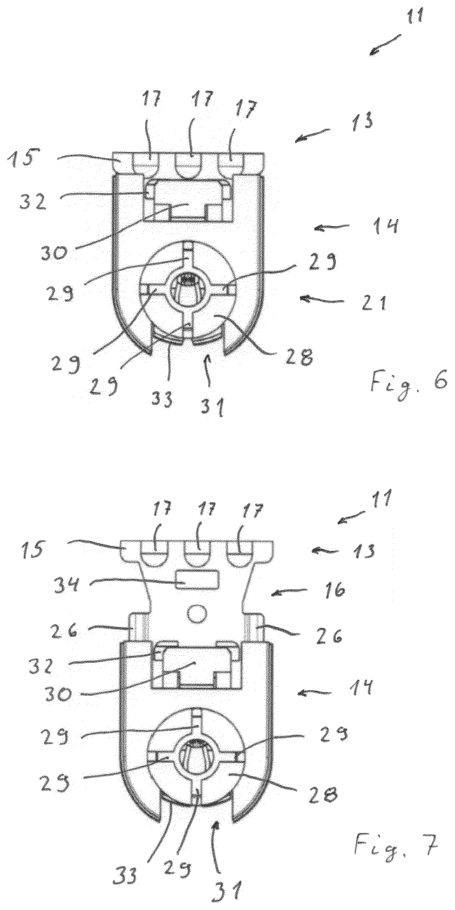

It can also be seen in the figure that the holder 14 has a latching hook 30 which, in the state shown, engages in a latching opening of the support section 16 not shown in the figure, which will be discussed in more detail below with reference to FIG. 7. In this way, the holder 14 is firmly attached to the support section 16 by means of the latching of the latching hook 30 into the latching opening and is secured against being pulled off by this latching.

The figure also shows a slide 31 on the holder 14. At its end facing the latching hook 30, the slide 31 has a ramp 32 for disengaging the latching hook 30 from the latching opening. At the end facing away from the ramp 32, the slide 31 has a handle 33. With the handle 33, the slide 31 can be displaced in the direction of the latching hook 30 in such a way that the latching hook 30 is lifted with the ramp 32 from the support section 16, so that the latching hook 30 and latching opening are disengaged and thus the holder 14 can be pulled off the support section 16 again.

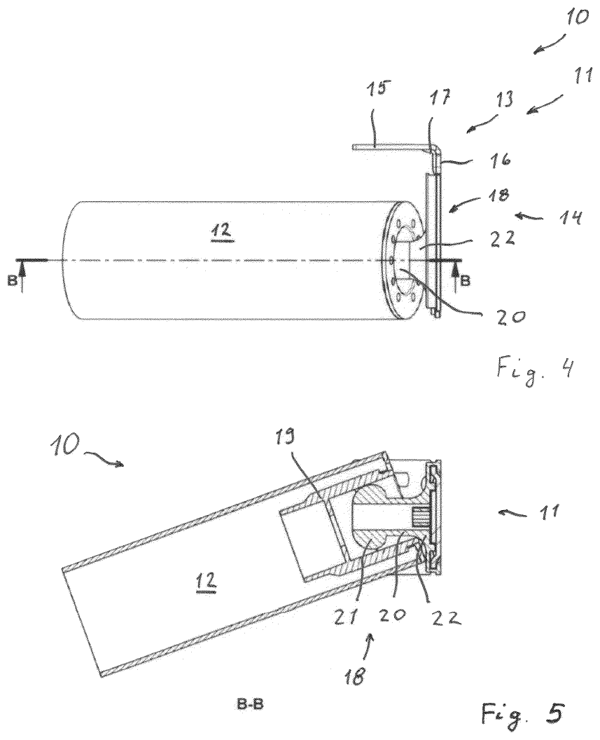

FIG. 4 shows the shade system 10 in a representation similar to FIG. 1 with pivoted winding shaft 12. In the figure, the winding shaft 12 is pivoted away from the observer into the plane of the paper of the figure for assembly or disassembly.

FIG. 5 shows section B-B of FIG. 4. As can be seen from the figure, the winding shaft 12 is pivoted strongly against the bearing pin 18 for assembly or disassembly. Due to the mushroom-shaped contour of the bearing pin 18 with the wider bearing head 21 and the narrower spacer 20, this is possible over a relatively large swivel range. In the state shown, the winding shaft 12 is still held securely by the bearing head 21, while the end of the bearing mount 19 comes to rest against the spacer 20. As can also be seen from the figure, the bearing configured in this way with the bearing head 21, the spacer 20 and the bearing mount 19 also allows length compensation within wide limits during assembly, as long as only the bearing head 21 comes to rest in the bearing mount 19.

FIG. 6 shows the holder 14 of FIG. 1 in an unlatched state. The slide 31 has been moved towards the latching hook by means of the handle 33, upwards in the figure. As a result, the ramp 32 slides under the latching hook 30 and the latching hook 30 is lifted away from the latching opening not shown in the figure. The latching connection between the latching hook 30 and the latching opening is disengaged in this way, so that the holder 14 can be pulled off the fastening piece 13 in the direction of the support section 16 facing away from the fastening section 15, downwards in the figure.

FIG. 7 shows the holder 14 of FIG. 1 in the disengaged state, largely removed (pulled off) from the fastening piece 13. The latching opening 34, in the support section 16, can be seen in the figure. In the state shown, the holder 14 can be completely removed from the support section 16. In order to remount the holder 14 on the fastening piece 15, the slide 31 is moved away from the latching hook 30, downwards in the figure, by means of spring means not shown in the figure or by actuating the handle 33 until the ramp 32 is no longer in engagement with the latching hook 30. In addition, the holder 14 is pushed back onto the support section 16 along the wings 26 guided in the grooves 23 until the latching hook 30 engages in the latching opening 34. The holder 14 is then latched onto the fastening piece 13 and the next step is to slide the winding shaft 12 onto the bearing pin 18.

A bearing 11 with the features of the invention can be used on one or both sides of the winding shaft 12. A suitable synthetic resin material can be used as the material for the holder 14. In the embodiment example, a thermoplastic material is provided as the material for the holder 14; in particular, manufacture as an injection-molded part is suitable.

While specific embodiments of the invention have been shown and described in detail to illustrate the application of the principles of the invention, it will be understood that the invention may be embodied otherwise without departing from such principles.

### LIST OF REFERENCE NUMBERS

10 Shade system
11 Bearing
12 Winding shaft
13 Fastening piece
14 Holder
15 Fastening section
16 Support section
17 Ribs
18 Bearing pin
19 Bearing support
20 Spacer
21 Bearing head
22 Extension
23 Groove
24 Distance clement
25 Strips
26 Wings
27 Opening
28 Disk
29 Web
30 Latching hook
31 Slide
32 Ramp
33 Handle
34 Latching opening
35 Stop

What is claimed is:

1. A bearing for supporting a winding shaft of a shade system, the bearing comprising:
a holder; and
an elongate bearing pin extending from the holder, the bearing pin comprising a spacer and a bearing head, wherein the spacer is a narrower spacer than the wider bearing head and the wider bearing head is spaced from the holder by the narrower spacer.

2. A bearing according to claim 1, wherein the bearing head has a round outer contour, at least in sections.

3. A bearing according to claim 1, wherein the bearing head is bead-shaped with a semi-circular cross-section or is spherical.

4. A bearing according to claim 1, wherein the bearing head has a circular disk-shaped configuration.

5. A bearing according to claim 4, wherein the bearing head has four webs which are spaced apart from one another.

6. A bearing according to claim 1, wherein the spacer has a cylindrical outer contour at least in sections and/or four webs which have a common cylindrical envelope end.

7. A bearing according to claim 1, wherein the spacer is widened at a spacer base facing the holder.

8. A bearing according to claim 1, further comprising a fastening piece configured to be fastened to a wall or a ceiling, the fastening piece being connectable to the holder.

9. A bearing according to claim 8, wherein the fastening piece comprises a support section, onto which the holder is attachable, and a fastening section configured to be fastened to the wall or ceiling, wherein the support section and/or the fastening section is of plate-shaped configuration at least in sections.

10. A bearing according to claim 8, wherein the holder has grooves on opposite sides from one another, for receiving the fastening piece.

11. A bearing according to claim 8, wherein the holder comprises a latching hook configured to latch to a latching section of the fastening piece.

12. A bearing according to claim 11, wherein a displaceable slide is provided on the holder, wherein the slide has a ramp for unlatching the latching hook.

13. A shade system, comprising:
a bearing, the bearing comprising: a holder; and an elongate bearing pin extending from the holder, the bearing pin comprising a spacer and a bearing head, wherein the spacer is a narrower spacer than the wider bearing head and the wider bearing head is spaced from the holder by the narrower spacer; and
a winding shaft with a bearing mount configured to receive the bearing head.

14. A shade system according to claim 13, wherein the bearing mount has a bearing head stop.

15. A shade system according to claim 13, wherein the bearing head has a round outer contour, at least in sections.

16. A shade system according to claim 13, wherein the bearing head has a circular disk-shaped configuration with webs, which are spaced apart from one another.

17. A shade system according to claim 13, wherein the spacer has a cylindrical outer contour at least in sections and/or is widened at a spacer base facing the holder.

18. A shade system according to claim 13, further comprising a fastening piece configured to be fastened to a wall or a ceiling, the fastening piece being connectable to the holder.

19. A shade system according to claim 18, wherein the fastening piece comprises a support section, onto which the holder is attachable, and a fastening section configured to be fastened to the wall or ceiling, wherein the support section and/or the fastening section is of plate-shaped configuration at least in sections.

20. A shade system according to claim 18, wherein the holder has grooves on opposite sides from one another, for receiving the fastening piece and wherein the holder comprises a latching hook configured to latch to a latching section of the fastening piece.
